(19) United States
(12) Patent Application Publication
(10) Pub. No.: US 2026/0298691 A1
(43) Pub. Date: Oct. 1, 2026

(54) STORAGE CONTAINER

(71) Applicant: KATHEMA GMBH, Donnerskirchen (AT)

(72) Inventor: Christian Johannes TOMASCHITZ, Donnerskirchen (AT)

(73) Assignee: KATHEMA GMBH, Donnerskirchen (AT)

(21) Appl. No.: 19/479,558

(22) PCT Filed: May 3, 2023
(86) PCT No.: PCT/EP2023/061609

§ 371 Date: Oct. 28, 2025

(51) Int. Cl. G01F 23/2962; A47J 47/02; B65D 51/24; G01F 23/18; G01F 23/292

(52) U.S. Cl. CPC G01F 23/2962; A47J 47/02; B65D 51/24; G01F 23/18; G01F 23/292; A47J 2203/00

(57) ABSTRACT

A storage container including electronic components, in particular a computing device and a first sensor which can communicate with each other. By providing a separate computing module in which at least the computing device is located, it is possible to protect the sensitive computing electronics from external influences particularly well and accommodate the computing electronics in the storage container in a protected manner but at the same time in a particularly maintenance-friendly manner as well.

### CROSS-REFERENCE TO RELATED APPLICATIONS

The present application is a national phase application of PCT Application No. PCT/EP2023/061609, filed May 3, 2023, entitled “STORAGE CONTAINER”, which is incorporated by reference in its entirety.

### BACKGROUND OF THE INVENTION

### 1. Field of the Invention

The present invention relates to a storage container for storing a substance, comprising a container with a base and a lid, wherein the container can be closed by the lid and, in a closed state, a receiving volume for receiving the substance is formed inside the container, a first sensor for measuring a first property of the receiving volume and/or the substance in the receiving volume, and a computing device, which computing device is designed to receive data from the first sensor and to send data to a first computer.

The present invention further relates to a system comprising a storage container, a server and a terminal, as well as a method for monitoring a fill level of a storage container using the system.

### 2. Description of the Related Art

Storage containers or Containers for storing food are known from the state of the art. These storage containers differ from one another, particularly in terms of their design. From a technical point of view, however, the well-known storage containers usually comprise a storage volume for food (such as pasta, flour, sugar, oat flakes, dried fruit) and a lid, whereby the lid may enable the storage volume to be sealed airtight. A more complicated structure or, in particular, the integration of electronic components is avoided in the state of the art, primarily due to the requirement of dishwasher resistance.

A disadvantage of well-known storage containers is that, especially when there are a large number of (possibly different) storage containers with usually different contents, the overview is quickly lost. This problem exists both in private households, but even more so in large or company kitchens or in the catering industry. In order to use a particular food supply, you often have to look through several storage containers and usually change their position (e.g. lift them) or even open them before you find the right storage container. In the worst case, you may even have to search through all the storage containers, only to find that the food supply you are looking for has already been used up.

Maintaining a certain minimum stock level or replenishing dwindling stocks is also complicated and time-consuming for the reasons described above. To ensure that there is always a sufficient supply of a certain type of food, the fill levels of the storage containers must be checked manually on a regular basis, the dwindling stocks identified and put on a shopping list, repurchased and refilled. The higher the number of storage containers available, the greater the time required.

The problems described above already occur when using storage containers whose contents are visible from the outside (e.g. glass containers); however, manual monitoring of the fill levels is particularly problematic when using opaque storage containers, such as those used for storing coffee or tea.

### SUMMARY OF THE INVENTION

An object of the present invention is therefore to provide a storage container which enables monitoring of fill levels of the food of different types and qualities stored therein. In particular, the storage container according to the invention should ensure safe, energy-efficient, very precise and position-independent fill level monitoring and, moreover, be dishwasher-safe. Further objects of the invention will become apparent from the description.

The invention solves the stated problem through the subject matter of the independent patent claims. Preferred embodiments emerge from the dependent patent claims, the description and the figures.

One object of the invention is achieved by a storage container of the type described above, in that the computing device is arranged inside a sealed computing module.

According to the invention, the storage container comprises a container with a base and a lid, wherein the container can be closed by the lid.

In a closed state of the container, i.e. when the container is closed by the lid, a receiving volume which is formed between the base and the lid and is laterally limited by one or more walls of the container is closed. The intake volume is designed to hold a specific amount of a substance, in particular a food supply. The base of the container can be arranged on an underside of the container or can be formed by the underside of the container. The lid of the storage container may be provided on top of the container to close the container; alternatively, the lid may be completely removable from the container and detachably connected to it.

The base can preferably be connected to the wall magnetically (or by means of a magnetic closure) to form the container. Alternatively or additionally, the lid can be connected magnetically (or by means of a magnetic closure) to the container, in particular to the wall of the container, in order to close the container. This makes the storage container particularly dishwasher-safe and easy to handle; it also significantly reduces maintenance requirements. According to the invention, the storage container also has a first sensor which is designed or configured to measure a first property of the substance in the receiving volume and/or a first property of the receiving volume itself. The first property can be, for example, a fill level, a weight or a fill volume of the substance; alternatively, the first property can also be, for example, a remaining partial volume of the absorption volume, i.e. that portion of the total absorption volume available for absorption of the substance that is currently not filled with substance.

Using the first sensor, for example, the quantity or fill level of the substance in the receiving volume can be determined.

According to the invention, a computing device is provided in the storage container for this purpose. The computing device is designed (or programmed or configured) to receive data from the first sensor and to send this or other data to a first receiver, such as a server, a mobile device or a computer. If necessary, the computing device can determine or calculate the first property from the (measurement) data of the first sensor and forward data relating to this property to the first receiver, for example for display to a user or for further processing to a server. In addition, the computing device can also be programmed to send and receive signals, for example to activate electronic components of the storage container or to communicate with other devices (for example, kitchen appliances can be switched on and off and/or controlled by the computing device). The computing device may be formed by a microcontroller or may include such a microcontroller.

If the computing device is also arranged within a sealed or separate computing module of the storage container, as provided according to the invention, an intelligent storage container with integrated computing logic can be provided, which storage container can also meet the requirements for cleaning and care of dishes for storing food. Sealed or separated in this context initially only means that the storage container has an area specifically designed to house the computing module, which area—independently of the remaining parts of the storage container—can be individually adapted to different requirements or needs. Usage profiles can be designed. In particular, the computing module can also be formed by a separate component, which component can be detachably connected to the container and/or the lid.

The computing module can be sealed, in particular, against the ingress of liquids and/or gases, which can reliably prevent liquid from penetrating into the interior of the computing module, for example when cleaning the storage container under running water or in a dishwasher, which would damage the sensitive electronic circuits of the computing devices. Since the tap water used to clean dishes is always enriched with various salts, even the smallest amounts of water or cleaning fluid can be enough to corrode and irreparably destroy the electronic circuits, components and contacts in the computing module.

The computing module can also be reliably sealed against the ingress of gases, especially moist air. This is particularly important when cleaning in dishwashers, where hot water vapor is generated during the drying process, which, if gas permeable, would condense inside the rake module after cooling.

This condensed water vapor would then settle on the electronic components in the computing module and in turn lead to corrosion of the sensitive circuits, components and contacts in the computing module.

By arranging the computing device in a computing module that is (essentially) hermetically sealed against external influences, an “intelligent” storage container can be provided that can be easily cleaned and is therefore particularly suitable for storing food.

Further preferred embodiments of the invention are presented below. Unless otherwise stated, the described design variants or only certain features of the individual design variants can be combined as desired with other design variants or features of other design variants.

According to one embodiment, the computing device can be designed to send data to a computer or a (mobile) terminal device. The computer and the (mobile) device can be set up to evaluate the received data. This makes it possible to create a storage container that is versatile and can be integrated into the Internet of Things. The storage container according to the invention is therefore particularly suitable for smart home environments.

According to one embodiment of the invention, the computing module can have a protection class of IPX5 or higher. In particular, the computing module can have a protection class of IPX6 or higher, preferably IPX7 or higher, particularly preferably IPX8 or higher, particularly advantageously IPX9 or higher. The protection class of the module is determined according to the DIN EN 60529 standard, edition 2014 September, with higher numbers indicating greater protection against water. If the computing module has a protection class of IPX5 or higher, it already provides reliable protection against jets of water from nozzles from any angle.

According to one embodiment of the invention, the computing module can be (essentially) hermetically sealed from the environment.

According to a variant of the invention, the computing module can be formed by casting the computing device into a plastic or synthetic resin matrix.

As a result, the storage container according to the invention can be manufactured in a particularly simple and cost-effective manner.

According to another variant, the hermetic sealing can be achieved by welding two housing parts to form the computing module. If the housing parts are made of plastic, For example, ultrasonic or friction welding processes are suitable for welding the housing parts.

According to another variant, the hermetic sealing can be achieved by gluing two housing parts to form the computing module. The bonding can be carried out, for example, using an adhesive that completely crosslinks between the bonding surfaces. This ensures that no holes remain in the adhesive seam, which could allow water or moisture to penetrate. liquid would be possible.

According to a further variant, the hermetic sealing can be achieved by joining two housing parts to form the computing module, wherein the housing parts each form, in particular, congruent sealing surfaces and wherein a seal, for example a sealing ring, is provided between the sealing surfaces. Cutting rings can also be provided on the sealing surfaces to increase the sealing capacity.

According to one embodiment of the invention, the first sensor may comprise an ultrasonic sensor. The ultrasonic sensor can be configured to emit ultrasonic pulses and receive the emitted pulses again. For example, the propagation time of the emitted pulses can be measured and the distance between the sensor and a reflective material can be determined. For example, the fill level of the substance in the receiving volume can be determined.

Alternatively or additionally, the first sensor may comprise a pressure sensor. Such a pressure sensor can, for example, be a piezoresistive pressure sensor, in particular a strain gauge (DMS), and can be mounted on a component of the storage container, in particular the container. When the component is deformed, for example due to an applied force or weight, the pressure sensor changes its electrical resistance. The change in the resistance value can be calibrated to a specific acting force, which enables, for example, precise weight determination. A piezoelectric pressure sensor can also be provided, which generates an electrical voltage when a force is applied. In this way, even extremely low fill levels can be determined precisely.

Furthermore, the first sensor may comprise an optical sensor. Such an optical sensor can, for example, be designed as a laser sensor. Laser sensors, for example, send a pulsed laser beam via a laser diode. Laser pulses and measure the travel time of the emitted pulses. This allows a distance between the laser sensor and a substance to be determined. By using several laser sensors simultaneously, which is preferred, triangulation can also be carried out, which enables the determination of the surface contour of a substance. Thus, at the same time as determining the fill level, the condition or the type of substance in the absorption volume must be checked. The optical sensor can also be designed as an infrared sensor. Such an infrared sensor can emit an electrical signal that depends on the distance between the sensor and the substance. Alternatively, the optical sensor can also a light barrier, in particular a laser light barrier, which light barrier can be arranged on the inside of the wall of the container in order to measure a filling height or a filling level.

Preferably, several light barriers can be provided, in particular equidistant in the height direction.

Furthermore, the first sensor can also comprise one (or more) temperature sensors in order to determine a temperature inside the storage container, in particular in the receiving volume. This ensures that the substance contained in the receiving volume, in particular the food supply, is stored at the appropriate temperature, and the storage container according to the invention can also be used for the quality control of food (for example in accordance with hazard analysis and critical control points, abbreviated to HACCP).

The sensors described above thus enable a reliable determination of a first property of the substance in the absorption volume. Alternatively or additionally, the first sensor (the first measuring device) may also comprise other or additional sensors.

According to one embodiment variant, the computing module can be arranged in the base of the container. A structurally simple storage container can thus be created, since the lid of the storage container and also the wall of the container can each be free of the calculation module and thus simply constructed. In addition, if the computing module is arranged in the base, the lids can be replaced at any time.

According to a further embodiment, the computing module can be arranged in the lid of the container. Particularly in versions where all electronic components (sensors, computing devices, etc.) are housed in the lid of the storage container, this results in an advantageous modular design that improves the handling of the storage container, especially with regard to cleaning and maintenance. In addition, the computing module is particularly easy to replace when it is housed in the lid of the storage container, which makes repairs particularly easy. In addition, different calculation modules can be attached to one and the same container, for example for different types of substances, which makes it particularly easy to adapt the storage container to different requirements. For example, in the case of the uptake of liquid substances, different computing modules and/or sensors can be used than in the case of the uptake of solid substances.

Preferably, the computing module can be detachably connected to the base or the lid; it can thus be removed from the base or the lid and reinserted as needed. The maintenance options for the storage container can be improved and simplified, as it allows for easy removal of a defective computing module and insertion of a new one.

According to a further embodiment, the computing module can have contacts on its outside, preferably waterproof ones. The contacts of the computing module can be connected to the computing device inside the computing module. The waterproof contacts on the outside ensure that the computing module can be connected to electronic components outside the computing module and is also sealed against the ingress of liquids and/or gases.

Preferably, the contacts of the computing module can be connected to the computing device inside the computing module via waterproof contact bushings. Such waterproof contact feedthroughs can be produced, for example, by casting/potting or gluing electrical cables into housing parts, such as the base and/or wall of the container, and/or lid.

Preferably, the contacts of the computing module may further have a corrosion-resistant (or a corrosion-resistance-improving) surface treatment. Particularly preferably, the contacts of the computing module can be gold-plated. This achieves, on the one hand, a particularly low contact resistance, which can minimize measurement errors or interference signals in the connection between the computing device and the first sensor, and, on the other hand, a high corrosion resistance, which means that the contacts are not prone to corrosion even with frequent contact with water or cleaning solutions.

According to a further embodiment, the container may have first electrical lines for connecting the computing device to the first sensor; in other words, the computing device and the first sensor may be connected to one another via the first electrical lines. The first electrical lines can be guided in a wall or in another housing part of the container, such as the base, so that they are protected against external influences, in particular against corrosion.

Preferably, the first electrical lines in the container are connected to counter contacts (or the electrical lines have such counter contacts), wherein the counter contacts are designed to receive the contacts of the computing module. When the contacts of the computing module are connected to the corresponding mating contacts in the container, a reliable electrical connection between the computing device and the first electrical lines in the container is made possible without having to accept any compromises regarding the tightness of the computing module and the container. In particular, waterproof plug contacts can be provided for connecting the computing device to the first electrical lines, which enables a particularly modular design of the storage container while maintaining protection against moisture.

According to a further embodiment, the first sensor can be arranged in the lid of the container. This is particularly advantageous when optical sensors or ultrasonic sensors are used as the first sensor (or part of the first sensor). For this purpose, the lid can preferably have waterproof contacts on one outside which are connected to the first sensor. The waterproof contacts on the lid ensure the tightness of the lid to prevent liquids and/or gases from penetrating the electronic components of the first sensor. As previously stated for the electrical contacts of the computing module, the contacts of the lid can also have a corrosion-resistant surface treatment, in particular gold plating.

Preferably, the lid is also detachably connected to the container. This way, a storage container that is easier to clean can be created. In addition, the modularity of the storage container can be improved. In particular, different lids can be used for the container. For example, different lids with different first sensors can be provided, which are preferably adapted to the respective application (e.g. adapted to different substances). A particularly flexible and reliable intelligent storage container can be created in this way.

According to a further embodiment, the first electrical lines in the container can be connected to mating contacts for receiving the contacts of the lid (or the first electrical lines can comprise such mating contacts). When the contacts of the lid are connected to the corresponding mating contacts in the container, preferably in its wall and/or base, in particular when the lid is placed on the container, a reliable electrical connection can be established between the first sensor in the lid and the first electrical lines in the container. If the contacts of the computing module (located, for example, in the lid, base, or wall of the container) are connected to the corresponding counter contacts in the container, a direct electrical connection is established between the first sensor in the lid and the computing device, and at the same time, all components of the storage container are waterproof. This makes it possible to create a particularly easy-to-use and reliable storage container. Preferably, the first electrical lines, the computing device and the first sensor, preferably also any further sensors of the storage container, are connected to one another via waterproof plug contacts.

According to a further embodiment, the first sensor can be arranged in the base of the container. This is particularly suitable if the first sensor is a pressure sensor. In this case, the computing module can also be provided in the base, which is particularly advantageous.

Preferably, the first sensor can be provided on the container bottom or integrated into the container bottom. For example, a strain gauge can be attached as the first sensor to the underside of the container bottom and thus measure the weight force of the substance in the receiving volume acting on the container bottom.

According to one variant, the container base can be designed to be self-supporting. The underside of the container bottom can be spaced from other elements in the base of the container, enabling particularly reliable measurement of the forces acting on the container bottom.

According to one embodiment of the invention, the storage container can have an energy source for supplying the computing device and/or the first sensor, and/or any further sensors or other electrical components of the storage container, such as a display, with electrical energy.

Preferably, the energy source can be a rechargeable battery.

According to a further embodiment, the energy source can be arranged inside a sealed or separate energy supply module, which is sealed in particular against the ingress of liquids and/or gases. Separate is to be understood here as explained above in connection with the calculation module. The energy supply module can be housed in the storage box in analogy to the computing module. Preferably, the energy supply module further comprises an induction coil in order to supply or charge the energy source with electrical energy as required, preferably in a contactless manner. It is also conceivable that the energy source itself is omitted, and the energy supply module of the storage container only comprises those components that are required to establish an electrically conductive connection between the electronic components of the storage container (sensors, computing device, etc.) and an external energy source.

According to one embodiment of the invention, the power supply module can have a protection class of IPX5 or higher. In particular, the power supply module can have a protection class of IPX6 or higher, preferably IPX7 or higher, particularly preferably IPX8 or higher, particularly advantageously IPX9 or higher.

The above statements regarding the computing module with regard to tightness, protection class and hermetic sealing apply analogously to the power supply module.

According to a variant embodiment of the invention, the energy supply module can be arranged in the base of the container.

A structurally simple and stable storage container can thus be created, since the energy supply module is a comparatively heavy component and, when arranged in the base, contributes positively to the stability of the container.

Preferably, the power supply module can be detachably connected to the base; it can thus be removed from the base and reinserted as needed. This allows for easy maintenance of the storage container, as a defective power supply module can be easily replaced. In addition, a discharged power supply module can be easily removed from the base for recharging and placed in be charged at an external charging station or exchanged with an already charged power supply module.

Preferably, the computing module, the power supply module, and at least the first sensor are arranged in the lid; alternatively, the computing module, the power supply module, and at least the first sensor can be arranged in the base.

According to one embodiment variant, it is provided that the energy supply module has on its outer side, preferably waterproof, contacts, which contacts are connected to the energy source. The contacts can be connected to the energy source inside the power supply module via waterproof contact bushings. The waterproof contacts on the outside ensure that the power supply module is both sealed against the ingress of liquids and/or gases and can be connected to electronic components outside the power supply module. The waterproof contact feedthroughs can be created, for example, by casting/potting or gluing electrical cables into housing parts of the power supply module.

In addition, the contacts of the power supply module can preferably have a corrosion-resistant surface treatment, in particular gold plating. For this purpose, reference is made to the above explanations regarding the contacts of the computing module, which can be applied analogously to the contacts of the power supply module.

According to one embodiment variant, it is provided that the container has second electrical lines for connecting the computing device and/or the first sensor to the energy source, wherein in particular the second electrical lines are connected to mating contacts for receiving the contacts of the energy supply module or have such mating contacts. The second electrical lines can be routed in a wall or in a housing part of the container so that they are protected against external influences, in particular against corrosion.

Preferably, the second electrical lines in the container are connected to mating contacts, wherein the mating contacts are designed to receive the contacts of the power supply module. When the contacts of the power supply module are connected to the corresponding mating contacts in the container, a reliable electrical connection between the energy source and the second electrical lines in the container is made possible without having to accept any compromises regarding the tightness of the power supply module and the container.

According to one embodiment of the invention, the first electrical lines and the second electrical lines can together form an electrical line bus in the container. The contacts of the computing module, the power supply module and the lid, as well as the corresponding counter contacts in the container, include all the cables routed in the container. electrical cables. This allows a modular and interchangeable system to be created in which modules with different functional scopes can be used.

According to a further preferred embodiment, it is provided that the storage container has an inclination sensor for measuring the inclination of the container, wherein the inclination sensor is designed in particular as a gyroscope sensor. This makes it possible to take into account any tilt or inclination—and the associated change in the positioning of the substance stored in the receiving volume—when determining the fill level. Particularly in embodiments in which the first sensor comprises the inclination sensor or the storage container has at least one further sensor in addition to the first sensor, which further sensor comprises a gyroscope sensor, in addition to the first property—for example a distance between the first sensor and a substance closest to the first sensor—information on the current position and orientation of the storage container (in three-dimensional space) can also be recorded. This eliminates the possibility of incorrect fill level measurements caused by incorrect positioning of the storage container, for example if it has fallen over. The reliability of the measurement of the first property, in particular a fill level and/or a remaining portion of the absorption volume, can thus be significantly improved.

According to a further preferred embodiment, it is provided that the storage container has a display, in particular an LED display, in order to display to a user at least one property of the receiving volume and/or the substance inside the receiving volume, in particular a weight, a volume, an expiration date or a type of substance, or at least one property of the container, in particular a fill level in the receiving volume. This increases the user-friendliness and handling of the storage container according to the invention.

According to a further preferred embodiment, it is provided that the storage container has means for generating an optical and/or acoustic signal in order to enable identification of the storage container on the basis of user-defined specifications and/or to be able to issue warning and error messages. For example, this makes it possible to uniquely identify an individual storage container at a specific time, depending on its contents, current fill level, etc. In particular, different storage containers with different food supplies can be identified in an order specified by a recipe displayed on the user's device, which can significantly simplify or accelerate processes—especially in commercial kitchens. Additionally or alternatively, warning messages can be issued after a measurement by the first sensor, for example when a critical value, such as fill level, is undershot.

According to a further preferred embodiment, it is provided that the computing device is programmed to generate activation signals in a sleep mode, for example from the first recipient. Furthermore, the computing device does not need to have any additional functionality in sleep mode. Only after receiving an activation signal, which activation signal can originate, for example, from a user's terminal device or from a server, can the computing device switch to a (more energy-intensive) operating mode. This allows the storage container according to the invention to be operated in a particularly energy-efficient manner.

Preferably, the computing device is further programmed to read out or receive data from the first sensor in the operating mode, in particular in periodic successive readout intervals, and, if necessary, to determine the first property of the receiving volume or of the substance in the receiving volume from the readout data. The computing device can also (only) put the first sensor (and/or any other sensors or other electronic components of the storage container) into an operating state in the operating mode. Overall, this further reduces the energy consumption of the storage container.

Preferably, the computing device is further programmed to switch from sleep mode to operating mode after receiving an activation signal. Thus, the computing device can function as a central control element for all electronic components of the storage container. In particular, until the activation signal is received, only the computing device can be supplied with energy, which computing device is in sleep mode until then and thus consumes very little energy; and only after receipt of the activation signal does the increased energy requirement of the computing device and all other electronic components (which can be activated separately by the computing device) need to be covered.

Preferably, the computing device is further programmed to switch from operating mode to sleep mode after an activation period has elapsed. Thus, what was stated above regarding the power supply of the computing device, the first sensor, and any other electronic components also applies in reverse; after receiving a shutdown signal—for example, due to the expiration of the activation period—the computing device is put back into sleep mode (or puts itself into this sleep mode), and the energy consumption of the storage container can thus be reduced to an absolute minimum.

Preferably, the computing device is further programmed to activate any measuring unit of the storage container, in particular the first sensor or further sensors, and/or other electronic components and, in particular after transmission of the data, in particular measurement data, to the first receiver, to deactivate it. Preferably, the computing device performs these functions only in operating mode.

Preferably, the computing device is further programmed to detect any measuring unit of the storage container, in particular the first sensor or further sensors, and/or to activate other electronic components due to an external signal, due to opening of the storage container, due to closing of the storage container and/or periodically, in particular after each expiry of a predeterminable or predetermined time interval. This enables event-related control of all components of the storage container, which further reduces the energy consumption of the storage container. In particular, the computing device can be programmed in such a way that the electronic components, including the first sensor, are activated upon closing the storage container in order to carry out an (initial) measurement of the fill level, the measured and/or processed data are transmitted by the computing device to the first receiver, for example a terminal device, and the electronic components of the storage container, including the first sensor, are deactivated again after a time interval, for example one minute, has elapsed and the computing device itself switches back to sleep mode.

According to a preferred embodiment variant, it is provided that the first sensor comprises a pressure sensor or is formed by this and the computing device comprises a microcontroller or is formed by this, wherein the pressure sensor and microcontroller are arranged in or on the base. For example, it can be provided that the computing module is arranged in the base or forms the base of the storage container, and that the pressure sensor is positioned on an outer surface of the base facing the receiving volume and is connected to the computing device. In particular, the first sensor can be formed by the pressure sensor and the computing device can be formed by the microcontroller. Since both the first sensor and the computing device are provided in or on the base, the storage container according to the invention has a particularly simple construction. Furthermore, this design variant already enables a reliable determination of the weight—and subsequently—the fill level of the substance in the receiving volume.

According to a preferred embodiment variant, it is provided that the first sensor comprises an optical sensor or is formed by this and the computing device comprises a microcontroller or is formed by this, wherein the optical sensor and the microcontroller are arranged in or on the lid. For example, it can be provided that the computing module is arranged in the lid or forms the lid of the storage container, and that the optical sensor is positioned on an outer surface of the lid facing the receiving volume and is connected to the computing device, in particular the microcontroller. In particular, the first sensor can be formed by the optical sensor. Since both the first sensor and the computing device are provided in or on the lid, the storage container according to the invention has a particularly simple construction. Furthermore, this design variant already enables a reliable determination of the filling level of the substance in the receiving volume or the free partial volume.

According to a preferred embodiment, it is provided that the first sensor comprises an ultrasonic sensor, which ultrasonic sensor is arranged, preferably centrally, in the lid. This enables a particularly precise and meaningful measurement of the substance facing the lid—and thus of the current fill level of the substance in the receiving volume.

According to a preferred embodiment, the first sensor comprises a gyroscope sensor, which gyroscope sensor is arranged in the lid or in the base. The measurement data from the gyroscope sensor make it possible to take into account any tilted or inclined position in which the storage container may be (usually unintentionally). This can then be taken into account subsequently, for example by the computing device, when calculating the actual fill level. Thus, the reliability of the storage container according to the invention with regard to fill level determination can be significantly improved.

One object of the invention is achieved by a system comprising at least one storage container according to one of the previously described embodiments, at least one server and at least one terminal, wherein
the computing device of the storage container is at least designed to
to transfer data to the server and/or to the terminal device, and
to receive signals from the server and/or the terminal device,
the server is at least set up to
to receive, process and/or transmit data from the storage container's computing device to the terminal device and/or external servers,
to receive, process and/or transmit data from the terminal device to the storage container's computer and/or external servers,
to transmit signals to the storage container's computing device, and
to receive, process and/or transmit external data to the terminal device and/or to the computing device of the storage container, and wherein
the terminal device is at least configured to
to transmit data to the server, the storage container's computer and/or external servers,
to transmit signals to the storage container's computing device, and
to receive data from the server, the storage container's computing device and/or external servers.

This system makes it possible to integrate the storage container according to the invention into a smart home or smart kitchen environment. In particular, data from several storage containers according to the invention can be combined, adjusted and/or processed with one another, for example in order to make work processes more efficient. For example, it is conceivable that the end user selects a recipe from a database via his (usually mobile) device, the device then sends a corresponding request to the server, which in turn has stored information on all existing storage containers, their contents and current fill level. If necessary, the server and/or the terminal device can now transmit signals to those storage containers which contain the food supplies required for the recipe. The computing devices of the respective storage containers can then initiate a check of the current fill level and transmit the result of this check to the terminal device and/or the server, for example in the form of a yes—this ingredient is available in sufficient quantity—or no—this ingredient is not available in sufficient quantity—signal. Alternatively, this yes/no signal can also be transmitted directly from the server to the end device based on the server data, without checking the actual fill levels, which results in further energy savings. The user can then initiate the recipe on their device, whereby the device can send signals to the required storage container in a sequence of recipe steps and at time intervals specified by the recipe or user in order to identify it—for example visually or acoustically—so that the search for the right storage container with the right food supply is no longer necessary. The computing device of the respective storage container from which the required amount of food is taken can initiate a (new) fill level determination after removal and transmit the result of this measurement to the server in order to update the fill level information stored there. If necessary, warning messages can be issued to the end user when a critical fill level is reached and/or corresponding order data can be transmitted to external servers, thus automating the ordering and refilling process. The user can also display specific recipes that aim to use up as much of the food stocks as possible before the respective expiration date, which can also be stored on the server.

The invention therefore also relates to a method for monitoring the fill level of a storage container using the system described above, the method comprising at least the following steps:
Measuring at least one property of the receiving volume of the storage container and/or the substance located in the receiving volume of the storage container, in particular food supplies, using the first sensor of the storage container and generating corresponding measurement data;
Transmitting the measurement data to the server using the storage container's computing device;
Processing of the measurement data by the server, in particular comparison of the measurement data with reference data, which reference data to the respective storage container and/or to the respective Substance, in particular food supplies, stored on the server or external servers;
Transmission of data and/or signals to the terminal device and/or to the computing device of the storage container by the server depending on the processing of the measurement data by the server.

### BRIEF DESCRIPTION OF THE DRAWINGS

In the following, embodiments of the invention are presented in more detail with reference to the drawings. The following description is neither intended to exhaustively explain nor restrict the inventive concept. The drawings show

FIG. 1 a schematic view of a first embodiment of the storage container according to the invention,

FIG. 2 a schematic view of a second embodiment of the storage container according to the invention.

### DETAILED DESCRIPTION

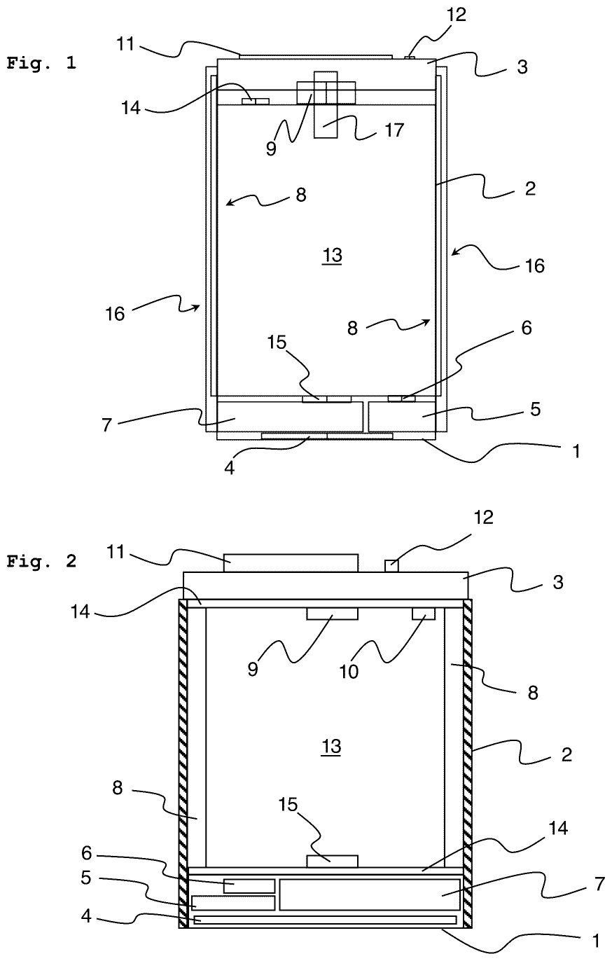

FIG. 1 shows the storage container according to the invention in a first embodiment. The storage container initially comprises a container which comprises a base 1 and a wall 2. Base 1 and wall 2 can be made in one piece or firmly connected to each other, or—preferably—detachably connected to each other. The container can be closed by means of a lid 3. In the interior of the storage container, more precisely in the space delimited by the base 1, wall 2 and lid 3, a receiving volume is thus formed, in which receiving volume 13 a substance, in particular a food supply, can be kept in stock or stored.

The lid 3 and the wall 2 can be detachably connected to one another via a closure 17, for example a bayonet closure.

According to the invention, the storage container has a computing device and at least one first sensor, wherein the computing device—and preferably also the first sensor and/or further, preferably all, electronic components—are accommodated in a sealed or separate computing module provided specifically for this purpose.

In the embodiment shown, the computing device is formed by a microcontroller 5, which microcontroller 5 is housed in the base 1 of the container. In the embodiment shown, the base forms the computing module of the storage container. Furthermore, further electronic components, namely an induction coil 4, a gyroscope 6 and a battery 7, are housed in the base. The base of the container represents a separate unit of the storage container, which can be designed and constructed according to the respective requirements. In particular, the base can be designed to be protected against water and/or gas ingress and can be detachably connected to the wall 2 of the container.

In the embodiment shown, the first sensor is formed by an infrared sensor 8, which is arranged on an inner side of the wall 2 facing the receiving volume 13. The infrared sensor 8 extends in a height direction, i.e. from the base 1 to the lid 3 of the storage container, and has several, for example more than 5, particularly preferably more than 10 or 100, preferably equidistantly arranged light barriers in order to be able to measure a fill level of the substance (food supply) located in the receiving volume.

In addition, the storage container shown comprises further electronic components, namely in particular an ultrasonic sensor 9, which also serves to measure the receiving volume 13 or the food supply located in the receiving volume 13, and a temperature sensor 14 for measuring an internal and/or ambient temperature; these are each mounted on an inner side of the lid 3 facing the receiving volume 13. In addition, the storage container comprises a pressure sensor 15, which is mounted on an inner side of the base 1 facing the receiving volume 13 and serves to measure a weight force acting on the base 1 and/or the (not shown) bottom of the wall 2, as well as a display 11 mounted on an outer side of the lid 3 facing away from the receiving volume 13 and an control element 12 provided there, which control element 12 is realized by several buttons. By means of the control element 12, the storage container can be controlled manually by the user, in particular the user can initiate measurements, enter information and/or initiate the display of certain information on the display 11.

FIG. 2 shows a second embodiment of a storage container according to the invention with the same components that have already been explained in connection with FIG. 1. Unlike in FIG. 1, the storage container of this embodiment also has an LED element 10, which is attached to the inside of the lid 3 facing the receiving volume 13 and serves for lighting purposes and/or optical signaling, and a further temperature sensor 14, which further temperature sensor 14 is attached to the inside of the base 1 facing the receiving volume 13. The LED element 10 can also be attached to the outside of the lid 3; particularly preferably, one or more LED elements 10 can be provided on the inside and outside of the lid 3.

The functioning of the invention (or individual aspects thereof) will now be described in more detail with reference to the exemplary embodiment shown in FIG. 2: Firstly, the storage container according to the invention is characterized in that the sensitive computing device and, if appropriate, further sensitive electronic components are accommodated in a separate computing module. Here, this calculation module is formed by the base 1 of the container, which base 1 is watertight and is detachably connected to the wall 2 of the container—acting as the bottom part of the container. This makes it easier to clean the storage container. In particular, the calculation module, i.e. here in base 1, The sealed design of the base protects the electronic components from water ingress.

In order to connect electronic components inside the separate computing module with those outside the computing module, electrical lines 16 (shown schematically only in FIG. 1) are provided, which are preferably laid inside the wall 2 and the lid 3 and are connected to contacts on an outer side of the base 1. These contacts are in turn connected to the computing device, in particular to the microcontroller 5, via waterproof contact bushings. The electrical lines and the electronic components can preferably be electrically connected to one another via waterproof plug contacts, wherein the plug contacts are provided on the base 1, the lower and upper edge region of the wall 2 and on the lid 3. Particularly preferably, these plug connections or plug contacts also provide the detachable fastening between base 1, wall 2 and lid 3.

In other embodiments, the computing module can also be formed by the lid 3 or can be accommodated as a separate component in the base 1 or in the lid 3.

Furthermore, the invention is intended to enable the precise measurement and retrieval of current fill levels in food storage containers and to determine the exact weight of the food filled in. Such monitoring should be possible in connection with a wide variety of foods (of solid as well as liquid consistency). The fill levels and weight should be further processed and displayed to end users (e.g. via an app). A key technical challenge is to ensure safe, energy-efficient and highly accurate measurement and transmission of fill levels and weight. In addition, the “intelligent” storage container should be dishwasher-safe according to existing standards (ÖNORM EN 12875-1) and be able to detect any inclination of the storage container and—with regard to determining the fill level—correct it, so that the correct weight and fill level can be displayed at any time, even when the container is inclined. Of course, the storage containers according to the invention can vary in size and shape.

In order to determine the fill levels, the storage container is equipped according to the invention with sensors, in particular with ultrasonic sensors 9 (such as B. Ping sensor from Parallax, HC-SR04), pressure sensors 15 (such as B. Flexiforce), infrared sensors 8, laser light barriers and/or with gyroscopes 6—one or more sensors of each type can be provided. Via the microcontroller 5 provided in or on the storage container (e.g. B. Raspberry PI Zero, Arduino) the data recorded by the sensors can be transmitted to a server using standardized communication for IoT devices (WLAN, Bluetooth—also Bluetooth Low Energy BLE, ZigBee—low energy), where it can be further processed and displayed to the end user via an app. The data can also be queried via a connection to a voice control system (e.g. Alexa, . . . ). In particular, when calculating the fill level or weight, the alignment/orientation of the storage container can be taken into account in order to correct measurements, that resulted from a tilt, accordingly. This means that the fill quantity or fill level can be displayed correctly even if a storage container is placed, for example, on the kitchen shelf at an angle e.g. of up to 45 degrees.

By application-controlled switching of the sensors and external communication on and off, the energy consumption of the intelligent storage container can be reduced to a minimum. This means that the microcontroller 5 only becomes active when certain events occur (e.g. B. after a wake-up command when needed or when opening and closing). In all other cases, the power supply remains switched off, ensuring maximum energy efficiency.

Furthermore, the user should be informed in a timely manner before the expiration date of the food or when the fill level falls below a minimum defined by the user. This has the advantage that there are always foodstuffs in the storage container that have not expired. Food cannot run out unnoticed. The information about the can (food, grams, expiration date) should be read via a display 11 in the lid 3 and/or via the app. The app can then be used to link to an online retailer so that the groceries can be reordered immediately.

Firstly, the storage container according to the invention comprises a measuring device for detecting a filling quantity or a filling level (or another property of the receiving volume or of the food supply stored in the receiving volume) as well as a display and/or data transmission device (computing device) for displaying and/or processing and transmitting the (possibly processed) measurement data of the measuring device and/or other data to a server. The measuring device and the display and/or data transmission device are generally in the off state, and only in the case of user-induced activation, which preferably occurs by means of a wirelessly transmitted activation signal, are they switched to the on state (for a predetermined period of time). This makes the storage container according to the invention particularly energy-efficient. Dishwasher resistance is ensured by accommodating all sensors that form the measuring device, microcontrollers of the display and/or data transmission device and, if necessary, other electronic components in a waterproof module of the storage container (computing module).

The storage container has a modular design and the individual parts—lid 3, container (with container wall or wall 2 and container base or base 1), electronic components and/or connections or Cables 16—can be removed. Depending on the model, a battery or rechargeable battery 7 is installed in the base, which can be charged by induction (using a charging station adapted to the storage container). Preferably, shelves can have corresponding container receptacles, wherein each container receptacle also has a corresponding charging station. Or there may be a battery compartment on the storage container where batteries of a specific type (e.g. B. AA, AAA) can be used. In particular, a container holder for one or more of the inventive Storage containers may be provided which are equipped with induction charging stations or which enable the power supply of several storage containers; in this case, the battery or rechargeable battery 7 may even be omitted.

Starting from the base 1, contacts (not shown) enable communication with the display 11 in the lid 3 as well as with the sensors mentioned, which sensors can be installed on the wall 2, the base 1 and/or in the lid 3 of the storage container.

All three parts, lid 3, wall 2 and base 1, can be detachably connected to each other and are therefore removable and washable.

In addition, lid 3 and base 1 (similar to mobile phones) are themselves waterproof and the contacts for connecting to the sensors are implemented using waterproof plug connections. All sensors can be designed to be waterproof themselves or housed in separate, water-protected modules. This means that all components are dishwasher safe.

The bottom portion of the storage container, which may be formed by the base 1, may be equipped with a pressure sensor 15 and a microcontroller 5, wherein the entire bottom portion is designed to be watertight, as outlined above. The pressure sensor 15 measures how strongly the base 1 is pressed by changes in pressure and thus the change in resistance and thus (indirectly) determines the weight of the filling material (if necessary taking into account the type of the respective filling material and the dimensions of the receiving volume 13). Furthermore, it can be provided that several light barriers (infrared sensors 8 or Laser) are arranged, which are equidistant from one another in the height direction and are connected in a signal-conducting manner to a microcontroller 5 mounted on/in one of the inner sides of the wall 2, in/on the lid 3 or in/on the base 1 of the storage container.

An ultrasonic sensor 9 can be installed in the lid 3 (for example, centered). By the ultrasonic sensor 9, such as. B. HC-SR04, it is possible to determine the distance to the surface of the contents (food supply) and the free volume inside the can (partial volume of the receiving volume 13) can be calculated.

A gyroscope 6, which is mounted, for example, in the base 1 or the lid 3, measures the inclination of the can and allows this information to be included in the calculation of the fill level. If the storage container has fallen over, this can also be detected by the gyroscope 6.

An (LED) display 11 in or on the outside of the lid 3 is used to display information about the can (such as weight, fill level, expiration date, contents/food).

Furthermore, the storage container can be equipped with LED lights (LED elements 10) and/or loudspeakers (not shown).

This helps when searching for the cans, as they emit a visual or acoustic signal when activated via an application and the search is supported. They also serve as visual or acoustic feedback in the event of problems/errors.

A simple contact in the lid 1 of the can provide information about whether the container is properly closed with the lid 1.

Possible areas of application of the invention may be:

When filling the can, the user indicates which food has been filled into the can.

This can be determined by scanning (photographing) the barcode or by manual selection.
When scanning, a connection to the manufacturer or to a database stored in the app, which has been pre-filled with relevant data, enables quick retrieval of the material added and additional information about the food. This information is used to determine the fill level and weight of the storage box, which is done by the ultrasonic sensor. Additional sensors—light barrier or Pressure sensor—supports the measurement and provides additional information.
When the storage container is closed, the contact between lid 3 and wall 2 is closed, which serves as an activation signal for the computing device and can trigger a measurement of the fill level; the user can be informed of the measurement result via the display in the lid or via the app. If information such as the type of food is missing, the user may be asked to provide information about the contents of the storage container. If the storage container is not properly closed, the lid 3 is missing or the storage container has fallen over, this information can also be communicated to the user via the app or display. Alternatively or additionally, the respective problem (container not closed, no lid present, storage container is tilted, expiration date is imminent, minimum fill level not reached, battery almost empty, etc.) can be indicated visually, for example via LED elements, and/or acoustically (via loudspeaker/beeper).

The fill level, quantity, expiration date or other information relating to the respective substance or food supply can be retrieved and displayed via an app or directly on the storage container, for example on the display 11. This makes everyday shopping much easier—it's also quick and easy to check whether you have enough ingredients for your recipes.

In particular, it is also intended that one or more of the (intelligent) storage containers according to the invention are integrated into a smart home environment, which can, for example, display daily shopping lists via appropriate interfaces and, if necessary, transmit them to appropriate service providers. This enables the planning and coordination of necessary food purchases within the household, which leads to savings in time and energy resources. In addition, the end user, especially in a smart home environment, can also be provided with targeted recipe suggestions aimed at using up food supplies that are approaching their expiration date.

Another version of the storage container could contain several food storage volumes separated by partitions (not shown). Here, the different food items are registered individually and can be accessed individually via the application. If the storage box is divided at defined intervals (similar to a type case with a lid) and in each resulting subdivision (e.g. central) on the base pressure sensors and/or on the lid (e.g. If ultrasonic sensors are installed (e.g. centrally), the fill levels and weight of the food supply in each individual storage volume can also be measured.

In other environments, such as commercial kitchens/company kitchens, the intelligent storage containers can make a significant contribution to process optimization and resource conservation. For example, the current status of food available in the company can be retrieved. Ongoing consumption and associated trends (seasonal, daily) can also be displayed and serve as information for further processes (e.g. B. Order). By specifying the expiry date, you can cancel before expiry or Warnings can be given about spoilage of goods, which prevents wasting of resources. Another use case would be: the chef plans the meals for the week in advance and using stored recipes and the number of people expected as well as the current state of the food by retrieving the smart storage containers, the order can be determined or alternative dishes can be suggested.

Another use for the cans would be in shops with food storage boxes, such as coffee or tea houses (coffee cans, tea cans) and the like, where a process (e.g. B. orders, informing the managing director) is initiated and employees are supported in their daily work—the information can therefore make it easier to purchase the required goods, a warning can be given about a lack of ingredients/stock, or orders can be placed automatically and processes can be optimized.

In addition to making daily life easier, especially with regard to food shopping, the invention is also based on an ecological, sustainable idea: unnecessary purchases of food that is already in stock or forgetting or ignoring the corresponding expiration dates lead to considerable food waste. The invention aims to reduce such waste, particularly through the possibility of creating needs-based shopping lists for food supplies.

By forwarding such household-related demand data from the smart storage containers to local suppliers (possibly anonymized), supply bottlenecks can be avoided and even supply chains can be optimized. This improves the use of our environmental resources (e.g. Food, pollutant emissions, energy) and ensures sustainable improvement. Food producers can produce according to trends and current food quantities, which leads to optimization of energy consumption and transport, and can serve as essential information even for states in crisis situations.

Furthermore, based on the anonymized data, food exchanges can be created which, using artificial intelligence (AI) and possibly taking into account future plans of the users (extrapolations), can create suggestions and exchange food before it expires.

The connection of the intelligent storage containers to third-party systems enables a variety of applications based on the data from the storage containers. By taking certain parameters into account, automation of food ordering can be achieved in the future, e.g. B. automatic ordering from suppliers or Retail chains. These automatic orders can be controlled by parameters entered by users (best price, highest quality, regionality). From an ecological and sustainable perspective, the storage box should be made primarily, preferably entirely, from recycled material in order to conserve resources.

As described above, the electronics of the storage container include, among other things, a microcontroller for receiving and processing measurement data and for transmitting data to a receiver, at least one first sensor for measuring a property of the receiving volume or the food supply located in the receiving volume, and a display for reading the contents, weight, expiration date and other information. The lid, the housing or the wall, which wall can also have a wall base or be sleeve-shaped—i.e. open at the top and bottom—and the base are modular and can be detachably connected to one another. Alternatively, the base and wall can also be formed as one piece and can be detachably connected to the lid.

### LIST OF REFERENCE SYMBOLS

1 base
2 wall
3 lid
4 induction coil
5 microcontroller
6 gyroscope
7 battery (energy storage)
8 infrared sensor
9 ultrasonic sensor
10 LED element
11 display
12 control element
13 receiving volume
14 temperature sensor
15 pressure sensor
16 lines
17 closure

1-31. (canceled)

32. A storage container for storing a substance, comprising:
a container with a base and a lid, the container being closable by the lid and an internal receiving volume being formed inside the container for receiving the substance;
a first sensor for measuring a first property of the receiving volume and/or of the substance within the receiving volume; and
a computing unit configured to receive data from the first sensor and to transmit data to a first receiver, in particular a computer;
wherein the computing unit is arranged within a computing module, which computing module is sealed against the ingress of at least one of liquids and gases.

33. The storage container according to claim 32, wherein the computing module has a degree of protection according to DIN EN 60529 of IPX5 or higher.

34. The storage container according to claim 32, wherein the computing module has on its outer side waterproof contacts, the waterproof contacts being connected to the computing unit via watertight feedthroughs leading to the computing unit inside the computing module.

35. The storage container according to claim 34, wherein the first sensor is arranged in the lid, and that the lid has on an outer side waterproof contacts, the waterproof contacts being connected to the first sensor via watertight feedthroughs, the lid being detachably connected to the container.

36. The storage container according to claim 35, wherein the first electrical lines are connected to counter-contacts for receiving the contacts of the lid or comprise such counter-contacts.

37. The storage container according to claim 32, wherein:
the storage container comprises a power source or an energy storage device for supplying electrical energy to at least one of the computing unit and the first sensor;
the power source or energy storage device is arranged within a power supply module, which power supply module is sealed against the ingress of at least one of liquid and gases; and
the power supply module has a degree of protection according to DIN EN 60529 of IPX5 or higher.

38. The storage container according to claim 37, wherein the power supply module is at least one of:
arranged in the base of the container; and
detachably connected to the base of the container.

39. The storage container according to claim 37, wherein the power supply module has on its outer side waterproof contacts, the waterproof contacts being connected to the power source via watertight feedthroughs leading to the power source inside the power supply module.

40. The storage container according to claim 37, wherein:
the container comprises second electrical lines for connecting at least one of the computing unit and the first sensor with the power source or energy storage device; and
the second electrical lines are connected to counter-contacts for receiving the contacts of the power supply module or comprise such counter-contacts.

41. The storage container according to claim 32, wherein the storage container comprises a tilt sensor for measuring the inclination of the container, the tilt sensor being realized as a gyroscopic sensor.

42. The storage container according to claim 32, wherein the computing unit is programmed to receive activation signals from the first receiver in a standby mode.

43. The storage container according to claim 32, wherein the computing unit is programmed, in an operating mode, to read data from the first sensor and to determine the first property of the substance in the receiving volume from the read data.

44. The storage container according to claim 43, wherein the computing unit is programmed to switch from the standby mode to the operating mode upon receipt of an activation signal.

45. The storage container according to claim 43, wherein the computing unit is programmed to switch from the operating mode to the standby mode after the expiry of an activation duration.

46. The storage container according to claim 32, wherein the computing unit is programmed to at least one of:
activate a measuring unit of the storage container; and
deactivate the measuring unit after transmission of measurement data to the first receiver.

47. The storage container according to claim 46, wherein the computing unit is programmed to activate the measuring unit in response to at least one of:
an external signal;
upon opening or closing of the storage container; and
periodically after expiry of a predetermined or preset time interval.

48. The storage container according to claim 32, wherein the first sensor comprises a gyroscopic sensor, the gyroscopic sensor being arranged in the lid or in the base.

49. A system comprising:
at least one storage container according to claim 32;
at least one server; and
at least one terminal device;
wherein:
the computing unit of the storage container is at least configured to:
transmit data to at least one of the server and the terminal device, and
receive signals from at least one of the server and the terminal device;
the server is at least configured to:
at least one of receive, process, and transmit data from the computing unit of the storage container to at least one of the terminal device and external servers,
at least one of receive, process, and transmit data from the terminal device to at least one of the computing unit of the storage container and to the external servers,
transmit signals to the computing unit of the storage container, and
at least one of receive, process, and transmit external data to at least one of the terminal device and the computing unit of the storage container; and
the terminal device is at least configured to:
transmit data to at least one of the server, the computing unit of the storage container, and the external servers,
transmit signals to the computing unit of the storage container, and
receive data from at least one of the server, the computing unit of the storage container, and the external servers.

50. The system according to claim 49, wherein the computing unit is programmed to activate at least one of a display and means for generating at least one of an optical signal and an acoustic signal in response to at least one of an external signal, upon opening or closing of the storage container, and periodically after expiry of a predetermined or preset time interval.

51. A method for monitoring a fill level of a storage container using the system according to claim 49, the method comprising:
measuring at least one property of at least one of the receiving volume of the storage container and the substance located in the receiving volume of the storage container, and generating corresponding measurement data;
transmitting the measurement data to the server;
processing the measurement data by the server by comparing the measurement data with reference data, the reference data being stored on the server or on external servers and being related to at least one of the respective storage container and the respective substance; and
transmitting at least one of data and signals to the terminal device by the server depending on the processing of the measurement data by the server.
